(19) United States
(12) Patent Application Publication
(10) Pub. No.: US 2014/0104049 A1
(43) Pub. Date: Apr. 17, 2014

(54) Self-Contained, Obstacle Detection Assembly and Alert System

(71) Applicants: Mark Foss, Jacksonville, FL (US); Charles H. Keegan, Milton, MA (US); William Martin, Marlborough, MA (US)

(72) Inventors: Mark Foss, Jacksonville, FL (US); Charles H. Keegan, Milton, MA (US); William Martin, Marlborough, MA (US)

(21) Appl. No.: 13/653,580

(22) Filed: Oct. 17, 2012

(51) Int. Cl. B60Q 1/52

(52) U.S. Cl. CPC B60Q 1/525
USPC 340/435

(57) ABSTRACT

An improved, self-contained, obstacle detector assembly and alert system consisting of a weather resistant housing unit, a proximity probe frictionally attached to the front end of a rod positioned within a rod guide. Inside the detector assembly housing, the rod is connected to return spring, electrical switching mechanism, battery pack, and alarm system. When the impact probe encounters an obstacle, the rod is pushed into the housing and depresses a mechanical switching lever that contacts the ground plan effectively closing an electrical circuit activating the alarm thus alerting the operator that an obstacle has been encountered.

The primary objective of the invention is to provide an improved obstacle detector and alarm system that ALERTS the operator of modern motor vehicles of the immediate proximity of a curb, parking block, roof overhang, or similar impediment prior to impact.

### TECHNICAL FIELD

The present invention relates to the field of obstacle detectors and alarm systems, and more particularly, to a system that functions as an obstacle detector and alert system for use on various types of, and varied positions on, modern motor vehicles.

### BACKGROUND ART

Mechanical and electrical vehicle obstacle detectors and particularly curb “feelers” have been in use for a long period of time. The curb detectors which are used primarily to facilitate parking a vehicle generally employ a flexible probe that is attached to the side of a vehicle, near the front and back wheels. The probes are adjusted to rub against an obstruction on the side of the vehicle, such as a street curb, with a predetermined clearance between the obstruction and the vehicle. This rubbing creates a metallic noise that is supposed to be heard inside of the vehicle.

Other electrical/electronic detectors have been created that utilize distance metering, mono-pulse deviation-measurement processing, the transmitting/receiving of radio waves, or electrical oscillation when the curb detector strikes or scrapes against an obstacle on the side of the vehicle. These methods of detection are then applied to an electronics control unit that subsequently produce an alarm signal that energize a visual and/or audio alarm located inside the cab of the vehicle.

A search of the prior art did not disclose any patents that read directly on the claims of this instant invention. However, the following U.S. patents were considered related:

| U.S. PAT. NO. | INVENTOR | ISSUED |
|---|---|---|
| 7,907,475 | Matsukawa | 15 Mar. 2011 |
| 7,903,842 | Satonaka | 8 Mar. 2011 |
| 7,903,023 | Comic, et. al | 8 Mar. 2011 |
| 5,293,152 | Bussin et al | 8 Mar. 1994 |
| 5,485,140 | Bussin | 16 Jan. 1996 |
| 4,967,180 | Wang | 30 Oct. 1990 |
| 4,904,894 | Henry | |
| 4,870,868 | Gastgeb | 3 Oct. 1989 |
| 4,855,736 | Hsu | 8 Aug. 1989 |

U.S. Pat. No. 7,907,475 Matsukawa discloses an obstacle detecting system for a vehicle detects an obstacle by sending a transmitting wave and receiving a receiving wave, which is really a “reflection” of the transmitting wave by the obstacle. The system calculates a distance to the obstacle. The system varies directivity of the transmitting wave in accordance with the calculated distance. The directivity is lowered when the calculated distance is less than a predetermined reference distance, than when the calculated distance is greater than the predetermined reference distance.

U.S. Pat. No 7,903,842 Satonaka discloses a target position setting device that includes a distance meter, an imager, first and second calculating portions, a determination portion, and a setting portion. The distance meter measures a distance to an object around a vehicle. The imager takes an image of an environment around the vehicle. The first calculating portion calculates a first candidate of a target position of the vehicle according to a measuring result of the distance meter. The second calculating portion calculates a second candidate of the target position of the vehicle according to an imaging result of the imager. The determination portion determines whether a relationship between the first candidate and the second candidate meets a given condition. The setting portion sets the target position according to the second candidate of the target position when the determination portion determines that the relationship between the first candidate and the second candidate meets the given condition.

U.S. Pat. No. 7,903,023 Cornic, et. al. disclose an obstacle detection system notably more of an anti-collision system detecting obstacles on the ground or onboard a carrier. The detection system comprises at least two continuous-wave radars linked to a system for utilizing the detection data arising from the radars The detection system performs localization of an obstacle along a radial axis between a radar and the obstacle by calculating the distance between the radar and the obstacle); along a vertical axis with respect to a radar by calculating the elevation of the obstacle using mono-pulse deviation-measurement processing. The detection system performs localization of an obstacle along a horizontal axis transverse with respect to a sighting axis of a radar, by calculating the azimuthal position of the obstacle. The invention applies notably in respect of the detection of obstacles on the ground so as to avoid any collision between a taxiing aircraft and these obstacles

U.S. Pat. No. 5,293,152 Bussin et al patent discloses a vehicle obstacle detector and alarm system that alerts the driver of a motor vehicle when the vehicle encounters an obstacle. The system consists of an obstacle detector assembly that includes a front probe that houses a piezoelectric element and that is attached to the curb side of a vehicle. When the probe scrapes against an obstacle, it produces electrical oscillations. The oscillations are applied to an electronics control unit that subsequently produces an alarm signal that energizes a visual and/or audio alarm located in the cab of the vehicle.

U.S. Pat. No. 5,485,140 Bussin patent discloses an electronically complex vehicle obstacle detector that includes an acoustic transducer cavity and a piezoelectric acoustic transducer that operates when a series of mechanical oscillations are transmitted through the flexible rod to the piezoelectric acoustic transducer. The transducer produces a series of electrical pulses, corresponding to the mechanical oscillations that are then applied through a cable to an electronics control unit. The unit processes the electrical pulses and subsequently provides an alarm signal that energizes an audio and visual alarm that alerts the driver of a motor vehicle when the vehicle has encountered an obstacle

The U.S. Pat. No. 4,967,180 Wang patent discloses a pre-impact alarm apparatus that signals the driver of a motor vehicle that obstacles exist in the path of the vehicle when the vehicle is backing-up. The alarm apparatus consists of a flexible sensing bar that projects from the rear of the vehicle. The bar includes an electrical impact head that is electrically attached to a buzzer located within the vehicle. When the sensing bar impacts an obstacle, the impact head closes a set of contacts that energizes the buzzer.

The U.S. Pat. No. 4,904,894 Henry patent discloses a hail sensor that uses a plurality of piezoelectric transducer positioned to produce an output signal when it is vibrated by a hailstone. The transducer output is supplied to a conventional signal processing circuit such as peak detectors and counters, which detect the electrical signal produced by the transducers.

The U.S. Pat. No. 4,870,868 Gastgeb patent discloses a sensing device which produces a response when the point of impact between an object and a member occurs at a preselected location on the member. The sensing apparatus includes a piezoelectric sensor that produces an oscillatory electrical signal which is proportional to the vibration in the member generated by the collision between the object and the member. Appropriate circuitry is provided for analyzing the oscillatory electrical signal and for producing a response if the object impacted the member at a preselected location.

The U.S. Pat. No. 4,855,736 Hsu patent discloses an electronic parking sensor apparatus having a base for attaching to a vehicle. The apparatus includes a flexible probe for contacting an impending obstacle. The probe is electrically attached to an electronics alarm unit that includes a filter circuit, an alarm circuit and is equipped with a pair of 1.5 volt cells that supplies the power to the alarm unit. The filter includes a timer for activating the alarm circuit when the electrical signal continues beyond a first interval which varies between 0.05 to 1.0 seconds. The timer also prevents activation of the alarm unit beyond a second longer interval that varies between 10 to 40 seconds. Separate front and rear transmitter units can operate on different signal frequencies for separately indicating front and rear contact with the obstruction.

For background purposes and as indicative of the art to which the invention is related, reference may be made to the following remaining patents also found in the search.

| U.S. PAT. NO. | INVENTOR | ISSUED |
|---|---|---|
| 4,585,898 | Beer | 15 Jul. 1986 |
| 4,519,245 | Evans | 28 May 1985 |
| 4,488,873 | Bloomfield et al | 18 Dec.1984 |

### DISCLOSURE OF THE INVENTION

Modern vehicles are much lower than those of the past and have a much more aerodynamic profile. Modern designs include air spoilers, air dams, or air foils that may located under the front, sides, or rear of the vehicle. This further lowers the overall profile of the vehicle. It is common for drivers to scrape the lower body panels, air spoilers, or air dams of their vehicles across a parking limiters or curbs causing expensive body damage. The improved vehicle obstacle detector and alert system is designed to alert the driver of a motor vehicle, such as an automobile, truck, recreational vehicle, that the vehicle has encountered an obstacle that is higher than lowest body panels of the vehicle. When alerted, the driver can take evasive action to prevent impact and/or any further damage to the vehicle. As seen in the individually labeled items in FIGS. 1-3, the invention consists of several elements including: a weather resistant housing unit (4), an obstacle detector probe assembly (1,2,3,5) and an electronic alarming system (6,7,8,9) combined into a single, self-contained, fully functioning unit (FIG. 4).

The weather resistant housing unit (4) attaches to a body panel located either on the front, side, rear, or top (or multiples thereof) of a modem automobile, truck, or recreational vehicle. The unit can be adjusted via mounting to ensure proper alignment on the lowest (or highest) body panel of the vehicle.

The obstacle detector assembly consists of a flexible impact probe (1) that is frictionally attached to the front end of a rod (2) that passes through a rod guide (3), and a return spring (5) within in the weather resistant housing unit (4). The proximal of the rod and the impact probe, protrude forward from the assembly. The distal end of the rod (2) tracks longitudinally within cavity of the housing unit (4) and closes an electrical circuit switch (6 & 9) powered by a self-contained battery pack (7) and activated the alert system (8). A spring (5) within the system returns obstacle detector probe and rod (1 & 2) to the original position when the obstacle is disengaged. At that time, the alert ceases.

The electrical alerting system is a small alarm (8) that is contained within the cavity the housing assembly (4). One end of the alarm circuit is connected to the positive (+) end of the self-contained battery package (7). The second end of the circuit is connected to the negative (−) side of the switch assembly (6 & 9) that will be closed by the obstacle detector probe assembly (1, 2) when an obstacle is encountered. When the switch is closed by the obstacle detector probe/rod, the alarm will sound, or an optional visual signal will be activated. When the obstacle detector probe/rod returns to the original position, assisted by the return spring (5), the alarm switch (6 & 9) will open and the alert will cease.

In view of the above disclosure, it is the primary object of the invention to produce an improved obstacle detector and alarm system that easily attaches to a vehicle and that provides a vehicle operator with an instantaneous audible (or separate visual) alarm when the vehicle has encountered an obstacle that is to the front, side, or rear of the vehicle thereby reducing the possibility of extensive and/or expensive vehicle damage.

In addition to the primary object, additional objectives of the invention are to provide an improved obstacle detector and alarm system that:
a. is reliable and easy to install and operate with little or no maintenance,
b. can be used in both dry and inclement weather,
c. is cost-effective from both a consumer and manufacturers point of view,
d. and can be used in multiple applications.

These and other objects and advantages of the invention can be enhanced with the addition of external power packs and alerts (audio and/or visual) depending upon the need of application.

### BRIEF DESCRIPTION OF THE DRAWINGS

FIG. 1 is an exploded view of the system showing the each of the major components of the obstacle detector system.

FIG. 2 is side elevation, cross section, view of the obstacle detector assembly illustrating the battery (power pack) side.

FIG. 3 is a side elevation, cross section, view of the obstacle detector assembly illustrating the alarm assembly (buzzer) side.

FIG. 4 is an illustration of the complete unit as it would be upon installation and utilization on a motor vehicle.

FIG. 5 is a representation of a vehicle (automobile, truck, RV) with multiple obstacle detectors installed (front lower panel, rear below bumper, roof) illustrating various placement options in anticipation of encountering a curb, parking limiter, or over hang.

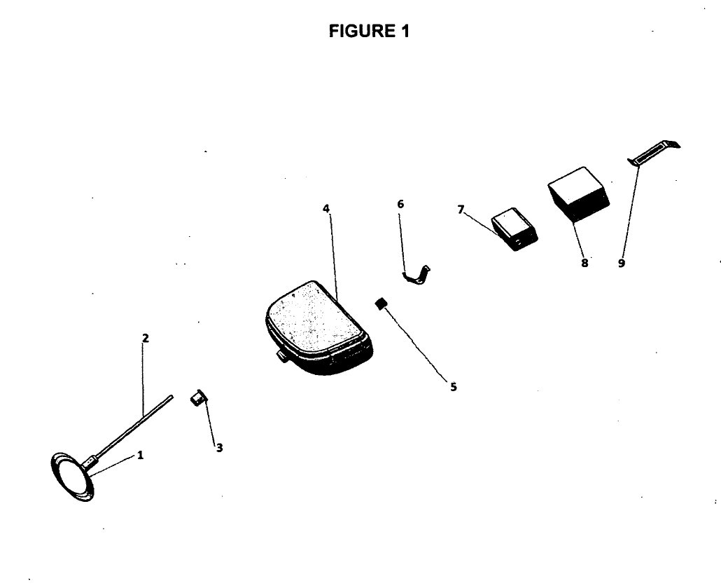

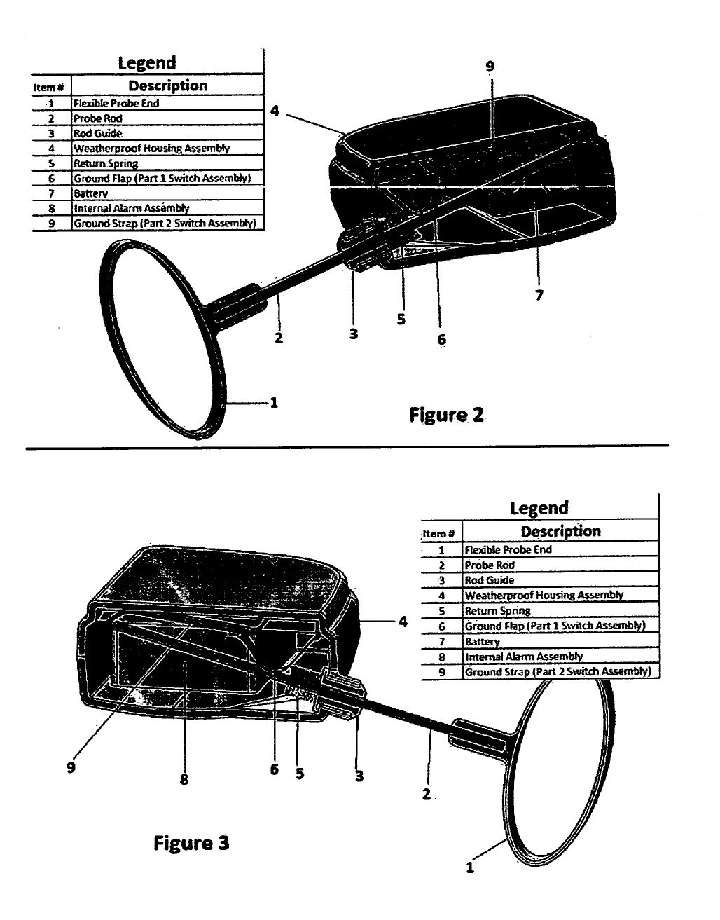

### BEST MODE FOR CARRYING OUT THE INVENTION

The best mode for carrying out the invention is presented in terms of a preferred embodiment that is a self-contained system designed to alert the operator of a vehicle, by means of an instant alarm when the vehicle has encountered an obstacle that is higher than the lowest (or highest point in the case of a truck or recreational vehicle) portion of the vehicle's body panels or undercarriage. FIG. 5.

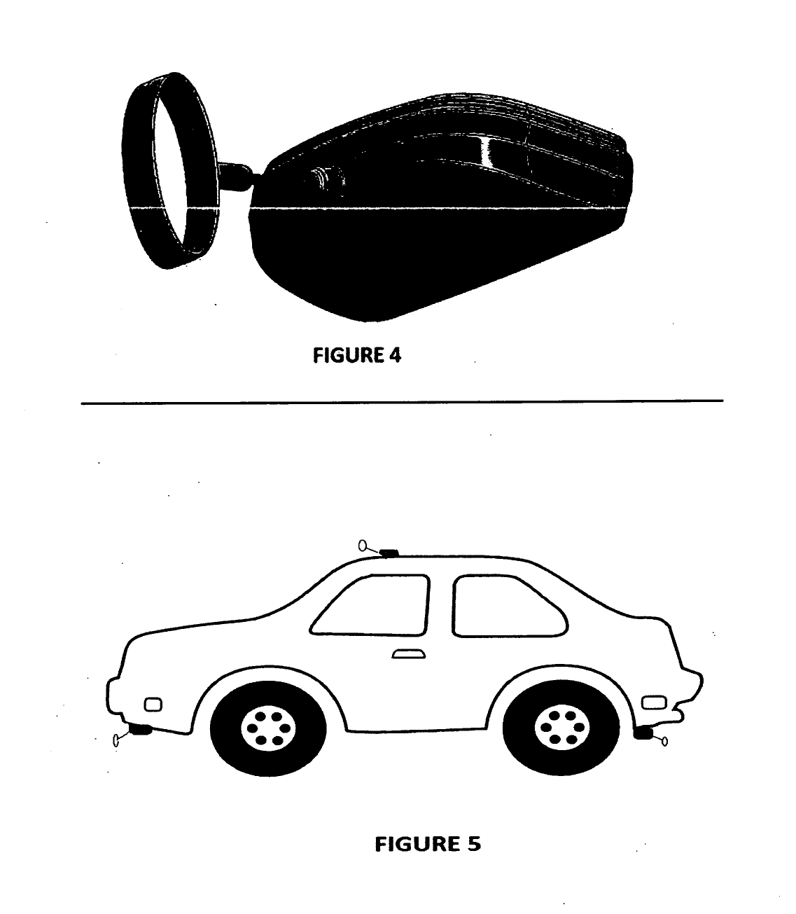

The preferred embodiment of the improved obstacle detector and alert system as shown in FIG. 4 is comprised of self-contained combination of three major elements: a weather resistant housing unit (1), an obstacle detector assembly (1,2,3,5), and an electrical alerting system (6,7,8,9).

The entire obstacle detector assembly (FIG. 4) is attached to lower front, back, or curb side of body panel a motor vehicle. The complete assembly is mounted in a plane that allows it to touch a parking limiter or street curb. A vehicle operator will be alerted when an obstacle that is higher than the lowest level of the vehicle is encountered thus avoiding any expensive vehicle damage.

Although a self-contained audible alarm construction is preferred, the alarm circuit can also connect to a visual LED light alert construction (not shown).

A means for attaching the assembly to a vehicle structure is provided. This means preferably consists of using high strength, double side, adhesive tape. Self tapping screws can also be used when required.

While the invention has been described in complete detail and pictorially shown in the accompanying drawings, it is not to be limited to such details, since many changes and modifications may be made to the invention without departing from the spirit and the scope thereof. For example, an auxiliary output can be added to the alert system (8) and the power supply (7) can be enhanced. This output could be used to provide the power to operate as an alarm light, claxon horn, remote alarm as would typically be used to detect an off-side, shifted load and shut-down the system before the shifted load causes a problem. Hence, it is described to cover any and all modifications and forms which may come within the language and scope of the claims.

We claim:

1. An improved obstacle detecting and alert system utilizing a proximity probe and electrical alerting system that is positioned on the front, rear, sides, or roof of a motor vehicle such as an automobile, truck, or recreational vehicle; configured to alert the operator of the immediate proximity of a curb, parking block, roof overhang, or similar impediment prior to impact.

2. The system of claim 1; fastened on an external building wall, door, loading dock, or other immobile structure that alerts those vehicle operators, workers, or bystanders that initial contact has been made between the moveable and immobile objects

3. The system of claim 1; fastened on an internal building wall, door, shelving, large furniture, or other large immobile object that alerts those moving smaller items that initial contact has been made between the moveable and immobile objects.
